(19) United States
(12) Patent Application Publication
(10) Pub. No.: US 2018/0036195 A1
(43) Pub. Date: Feb. 8, 2018

(54) FOOT MASSAGER HAVING STRETCH FUNCTION AND MASSAGE METHOD

(71) Applicant: Jianhan ZOU, Xiamen (CN)

(72) Inventors: Jianhan ZOU, Xiamen (CN); Guifeng HUANG, Xiamen (CN); Jianfeng ZHANG, Xiamen (CN)

(21) Appl. No.: 15/788,167

(22) Filed: Oct. 19, 2017

Related U.S. Application Data
(63) Continuation of application No. PCT/CN2015/078438, filed on May 7, 2015.

(30) Foreign Application Priority Data
Apr. 22, 2015 (CN) 201510192704.8

(51) Int. Cl. A61H 1/02; A61H 15/00

(52) U.S. Cl. CPC A61H 1/0266; A61H 15/0078; A61H 2015/0014; A61H 2201/1642; A61H 2201/12

(57) ABSTRACT

A foot massager having a stretch function includes a body including a housing having a massage cavity for placing the feet, and a foot massage mechanism provided below the massage cavity. A lower part of the body is connected to a support base supporting the body. An upper portion of the massage cavity has a massage air bag capable of squeezing and holding the feet in position. A rear part of the body corresponding to the heels is connected via a pin mechanism to the support base. A front part of the body corresponding to the toes is connected via a swing drive mechanism to the support base. The massage air bag expands, and squeezes the insteps, and holds the feet in position. The swing drive mechanism drives the body to use a pin as a fulcrum to swing up and down and to stretch and massage the feet.

### CROSS-REFERENCE TO RELATED PATENT APPLICATION

This application is a continuation application of International Patent Application No. PCT/CN2015/078438, filed on May 7, 2015, which itself claims priority to Chinese Patent Application No. CN201510192704.8 filed in China on Apr. 22, 2015. The disclosures of the above applications are incorporated herein in their entireties by reference.

Some references, which may include patents, patent applications and various publications, are cited and discussed in the description of this disclosure. The citation and/or discussion of such references is provided merely to clarify the description of the present disclosure and is not an admission that any such reference is “prior art” to the disclosure described herein. All references cited and discussed in this specification are incorporated herein by reference in their entireties and to the same extent as if each reference were individually incorporated by reference.

### FIELD

The present invention relates to a massage instrument, and particularly to a foot massager having a stretch function and a massage method.

### BACKGROUND

At present, there are various types of foot massagers available in the market, which however can only massage the people's feet. For example, Chinese Patent No. ZL201220417303.X entitled “FOOT MASSAGER” discloses a foot massager that can and only can massage the people's feet, and includes a casing; a drive mechanism; a toe massage mechanism which is actively mounted to the casing, and is connected to and driven by the drive mechanism; a foot center massage mechanism, which is actively mounted to the casing, and is connected to and driven by the toe massage mechanism; and a heel massage mechanism, which is actively mounted to the casing, and is connected to and driven by the foot center massage mechanism.

The foot massager massages the three parts of the feet through the toe massage mechanism, the foot center massage mechanism, and the heel massage mechanism, and has good massage effect. However, the foot massager can only massage the feet in a squeeze manner, and the massage function is simple and unsatisfactory.

### SUMMARY

To overcome the disadvantages existing in the prior art, the present invention provides a foot massager having stretch and massage functions and a massage method, by which the way of massage is increased.

To solve the above technical problem, the following technical solutions are adopted in the present invention.

A foot massager having a stretch function comprises a body comprising a housing and a foot massage mechanism. The housing is provided with a massage cavity for placing the feet. The foot massage mechanism is provided below the massage cavity. A lower part of the body is connected to a support base supporting the body. An upper portion of the massage cavity is provided with a massage air bag capable of squeezing and holding the feet in position. A rear part of the body corresponding to the heels is connected via a pin mechanism to the support base. A front part of the body corresponding to the toes is connected via a swing drive mechanism to the support base. The massage air bag expands and squeezes the insteps, and holds the feet in position. The swing drive mechanism drives the body to use a pin as a fulcrum to swing up and down and to stretch and massage the feet.

The technical solution can be further perfected by the technical measures below.

The swing drive mechanism includes a rotary member and a swing lever, and the body is provided with a rotating spindle rotating about a fixed axis. The rotary member is connected to the rotating spindle and driven to rotate by the rotating spindle. One end of the swing lever is hinged onto the rotary member at a position deviating from the axis of the rotating spindle, and the other end is hinged onto the support base. The rotating spindle has an outer end portion extending out of the housing, and the rotary member is fixedly connected to the outer end portion. The foot massage mechanism includes a motor, a drive means, a rotating spindle, and a massage means. The motor drives the massage means to undergo massage actions via the drive means and the rotating spindle. The massage means includes a roller fitted on the rotating spindle. The drive means is a gear drive mechanism, and the massage means further includes a carriage, on the top of which massage bumps are provided. The carriage is connected via a connecting rod and an eccentric wheel structure to the roller and driven by the roller to move forward and backward. The support base includes a front base, a rear base, and a basal plate, in which the front and rear bases are fixedly mounted on the basal plate. The swing lever is actively hinged onto the front base, and the pin is pivoted to the rear base. The basal plate is provided with a reinforcing plate and a shock absorbing leg. The housing has a through hole, and one end of the pin is fixedly fitted in the housing. The rear base is clamped with a pin sheath, and the other end of the pin passes through the through hole and runs into a bore in the pin sheath.

The swing drive mechanism may also be a telescopic push rod, an active push rod of which is hinged to the body, and a base of which is hinged to the support base.

A stretching and massage method by using the foot massager of the present invention comprises:

Step 1: inflating and expanding the massage air bag to hold the feet in position in the massage cavity; and

Step 2: massaging the feet by the foot massage mechanism, where at the same time, the swing drive mechanism is driven by the foot massage mechanism to swing, which in turn drives the feet to swing with the ankles as a fulcrum for stretching while massaging, where the swing angle of the body is greater than the swing angle of the feet in a free state.

By adopting the above technical solutions, the present invention has the following beneficial effects.

In the present invention, a front part corresponding to the toes is provided with a swing drive mechanism, a rear part corresponding to the heels is provided with a pin structure, and the swing drive mechanism drives a body to use the pin as a shaft of revolution to swing up and down. When the feet are held in position by an air bag located at an upper portion of a massage cavity, the body swings and drives the feet to swing about the ankles, thereby achieving the stretching and massage of the feet. In this way, the users can enjoy the experiences of squeezing and massage and also stretching and massage of the feet, thereby adding a massage function.

In the present invention, the body is driven to swing by the swing drive mechanism, and the swing drive mechanism includes a rotary member and a swing lever, and has the advantages of simple and compact structure and low cost.

Moreover, the present invention has the advantages of low noise and high structural strength because a shock absorbing leg and a reinforcing plate is provided on the basal plate.

### BRIEF DESCRIPTION OF THE DRAWINGS

FIG. 1 is a schematic view showing an overall structure of a foot massager according to a first embodiment of the present invention.

FIG. 2 is a schematic bottom view of the foot massager shown in FIG. 1.

FIG. 3 is a schematic view showing an internal structure of the foot massager shown in FIG. 1.

FIG. 4 is an enlarged view of the structure at position A in FIG. 3.

FIG. 5 is an enlarged view of the structure at position B in FIG. 3.

FIG. 6 is a schematic structural view showing the foot massager shown in FIG. 3 from which a base is removed.

FIG. 7 is an enlarged view of the structure at position C in FIG. 6.

FIG. 8 is an exploded view of a pin mechanism.

### LIST OF NUMERALS

1. body; 2. support base; 3. pin; 4. rotating spindle; 5. rotary member; 6. swing lever; 7. hinge base; 8. pin sheath; 20. reinforcing plate; 21. leg.

### DETAILED DESCRIPTION

The present invention will be described in further detail with reference to the accompanying drawings.

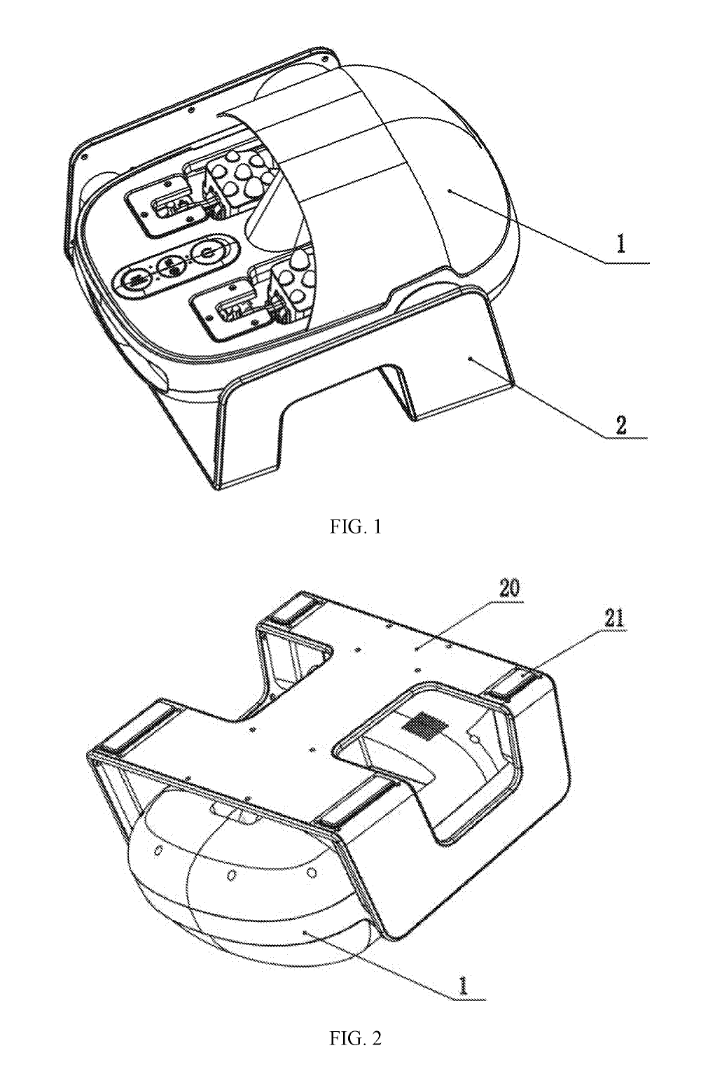

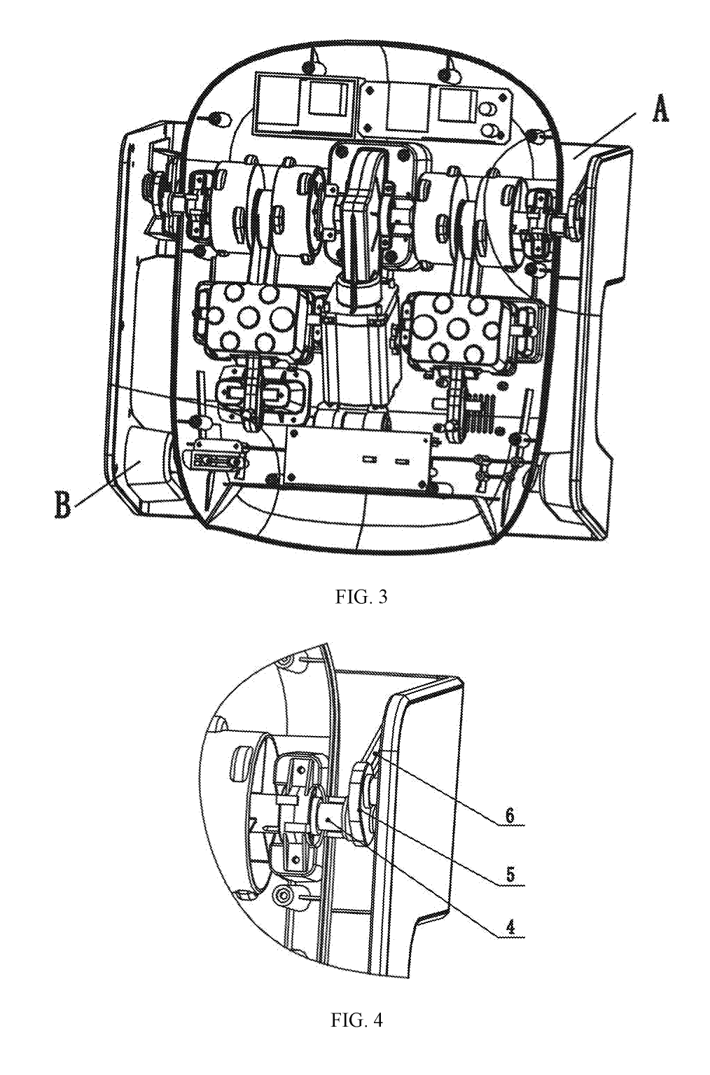

As shown in FIGS. 1, 2, and 3, a foot massager having a stretch function according to the present invention has a body 1. The body 1 includes a housing and a foot massage mechanism. The housing is provided with a massage cavity for placing the feet and having lining cloth capable of wrapping the feet. The housing includes an upper cover, a middle cover, and a lower cover. Both the upper cover and the middle cover are fixedly mounted onto a base, and the upper cover has two foot entrances through which the feet are put in. The massage cavity is located between the upper cover and the lower cover. The foot massage mechanism is provided below the massage cavity for massaging the feet. The foot massage mechanism includes a heel massage means, a foot center massage means, and a toe massage means. The specific structure of the foot massage mechanism may be made reference to the Chinese Patent No. CN201220417303.X of the present applicant, and the same structure is used in this embodiment. An upper portion of the massage cavity is provided with a massage air bag capable of squeezing and holding the feet in position. The massage air bag communicates with an air pump which is fixedly mounted in the body 1. The massage air bag is inflated by the air pump, such that the massage air bag expands, and squeezes and massages the feet from the top. A lower part of the body 1 is connected to a support base 2 supporting the body 1. A rear part of the body 1 corresponding to the heels is connected via a pin mechanism to the support base 2. A front part of the body 1 corresponding to the toes is connected via a swing drive mechanism to the support base 2. The so-called rear part corresponding to the heels is defined with the heels as a reference of the backward direction, rather than the heel position. Likewise, the front part corresponding to the toes is defined with the toes as a reference of the forward direction, rather than the toe position. When the massage air bag is in a pressure holding state after being inflated and expanding to a preset pressure, the massage air bag squeezes the insteps and holds the feet in position, such that the feet can not or can hardly move around in the massage cavity. At this time, the swing drive mechanism drives the body 1 to use a pin 3 as a fulcrum to swing up and down and to stretch and massage the feet, that is, the front part of the body 1 swings up and down with the rear part as a fulcrum of revolution. The foot massage mechanism includes a motor, a drive means, a rotating spindle 4, and a massage means. The rotating spindle 4 rotates about a fixed axis in the body 1, and the motor drives the massage means to undergo massage actions through the drive means and the rotating spindle 4. The massage means includes a roller fitted on the rotating spindle 4. The drive means is a gear drive mechanism, and details of the structure of the drive means may be made reference to Chinese Patent No. CN201220417303.X. The massage means further includes a carriage, on the top of which massage bumps are provided. The carriage is connected via a connecting rod and an eccentric wheel structure to the roller and driven by the roller to move forward and backward.

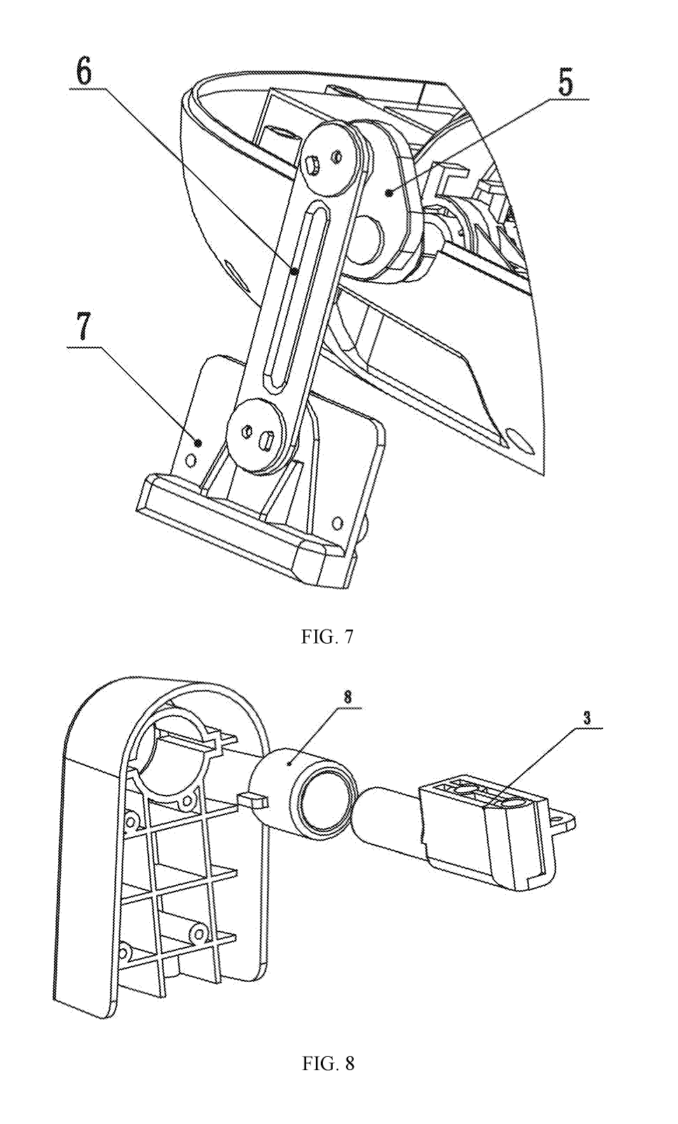

As shown in FIGS. 4, 6, and 7, the rotating spindle 4 has an outer end portion extending out of the housing, and the swing drive mechanism includes a rotary member 5 and a swing lever 6. The rotary member 5 is secured onto the outer end portion of the rotating spindle 4 and driven to rotate by the rotating spindle 4. One end of the swing lever 6 is hinged onto the rotary member 5 at a position deviating from the axis of the rotating spindle 4, and the other end is hinged onto the support base 2. The so-called hinged means that two components are connected by a pivot, so that they can rotate relative to each other, and the axis of the pivot is the axis of rotation. Since the swing lever 6 is hinged at an eccentric position of the rotary member 5, the swing lever 6 is caused to swing by the eccentricity when the rotary member 5 is rotated. The support base 2 has an overall groove-like structure, in which the front portion of the seat 2 is fixedly fitted with a hinge seat 7 at a position at the bottom of the groove. The hinge seat 7 has an upwardly extending connecting lug, on which a through hole is provided. A lower part of the swing lever 6 also has a through hole. A pivot passes through the through hole, then through the connecting lug and the swing lever 6, such that the swing lever 6 is hinged onto the hinge seat 7. A pivot spindle is fixedly provided on the rotary member 5 at a position deviating from the axis of the rotating spindle 4. The closer the pivot spindle is to the axis, the smaller the swing amplitude of the swing lever 6 will be. An upper part of the swing lever 6 has a through hole, through which the pivot spindle passes to hinge the swing lever 6 and the rotary member 5. In order to prevent the swing lever 6 from clamping stagnation due to the entering of foreign matters during the yawing process, a shroud is provided peripheral to the swing drive mechanism in the present invention, which is fixedly connected to the side surfaces of the support base 2. A metal reinforcing plate 20 and a shock absorbing leg 21 are provided at an outer side of a lower part of the support base 2. The metal reinforcing plate 20 is an iron plate secured to the under surface of the lower part of the support base 2. The shock absorbing leg 21 is a rubber member, which is secured to the basal plate and extends downward to contact a working plane, so as to reduce the noise and mechanical vibration of the present invention during use.

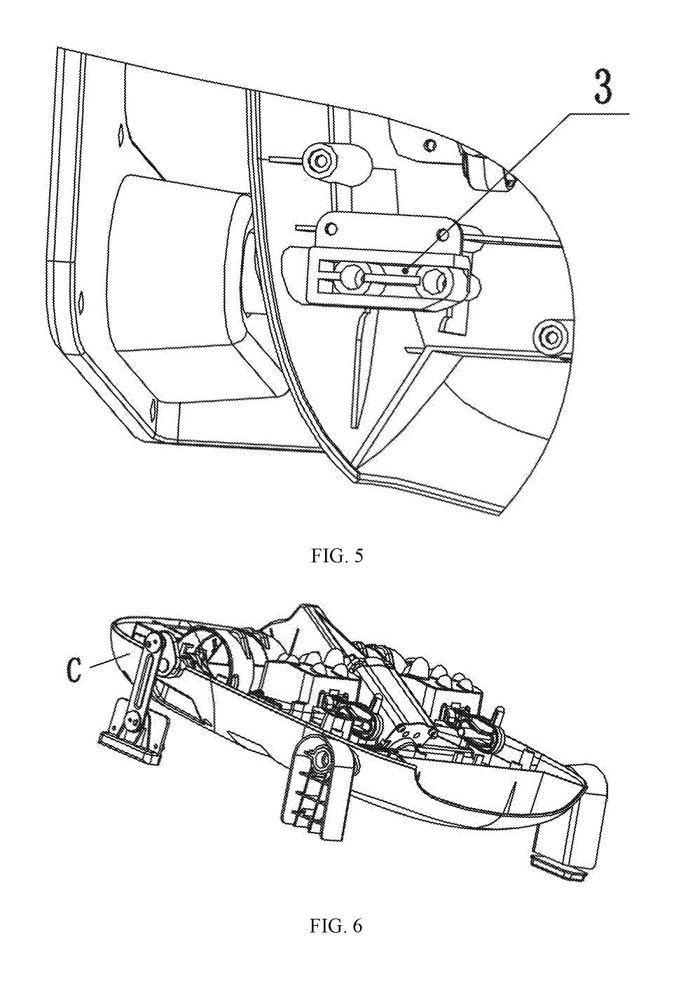

As shown in FIGS. 5 and 8, the pin mechanism includes a pin 3 and a sheath 8. The housing has a through hole, and one end of the pin 3 is fixedly fitted in the housing. The support base 2 has one seat for pin 3 at both sides, and one sheath 8 is clamped in the seat for pin 3. The other end of the pin 3 passes through the through hole and runs into a bore of the sheath 8. The seat for pin 3 has a through hole for fitting the sheath 8, and the through hole has two mounting slots extending along an axial direction of the through hole therein. The sheath 8 has, on an outer side thereof, two ribs mating with the mounting slots, where the ribs are engaged with the mounting slots. A sheath seat is provided at a tail of the pin 3, which is locked to the casing by a fastening screw. To prevent the pin mechanism from clamping stagnation due to the entering of dust and foreign matters during the operation, a shroud is provided peripheral to the pin mechanism.

A stretching and massage method by using the foot massager of this embodiment includes the following steps.

Step 1: inflating and expanding the massage air bag to hold the feet in position in the massage cavity, where the massage air bag squeezes and holds the feet in position from the top; and Step 2: massaging the feet by the foot massage mechanism, where at the same time, the swing drive mechanism is driven by the foot massage mechanism to work, such that the body 1 swings, which in turn drives the feet to swing with the ankles as a fulcrum for stretching while massaging, where the swing angle of the body 1 is greater than the swing angle of the feet in a free state.

During use, a user puts his/her feet in the massage cavity through the foot entrances, and then starts the foot massager by pressing a button. After the user selects a stretch and massage function, the air bump is activated by a controller and the massage air bag is inflated by the air bump. Then, the massage air bag expands and holds the feet in position on the middle cover. After inflation, the motor is activated by the controller, and drives the massage means to undergo massage actions by the drive means. At the same time, the rotating spindle 4 drives the rotary member 5 to rotate, whereby the swing lever 6 engages a yaw motion, such that the body 1 swings up and down with the pin 3 as a fulcrum, and the held feet are also stretched or withdrawn with the swinging of the body 1. When the feet are stretched, the foot muscles is relaxed, which can reduce the fatigue of the fee.

The forgoing description is merely a preferred embodiment of the present invention. In practice, those skilled in the art can also achieve the object of the invention by simple variations. For example, the swing drive mechanism may also be a push rod device, one end of which is hinged to the body 1, and the other end is hinged to the support base 2. The technical effect of the body 1 swinging with the pin 3 as a fulcrum can also be achieved with such a configuration. These technical solutions with simple variations also fall within the scope of protection of the present invention.

What is claimed is:

1. A foot massager having a stretch function, comprising a body comprising a housing and a foot massage mechanism, the housing is provided with a massage cavity for placing the feet, and the foot massage mechanism being provided below the massage cavity, wherein
a lower part of the body is connected to a support base supporting the body;
an upper portion of the massage cavity is provided with a massage air bag capable of squeezing and holding the feet in position; and
a rear part of the body corresponding to the heels is connected via a pin mechanism to the support base, a front part of the body corresponding to the toes is connected via a swing drive mechanism to the support base, the massage air bag expands, and squeezes the insteps, and holds the feet in position, and the swing drive mechanism drives the body to use a pin as a fulcrum to swing up and down and to stretch and massage the feet.

2. The foot massager according to claim 1, wherein the swing drive mechanism includes a rotary member and a swing lever; the body is provided with a rotating spindle rotating about a fixed axis; the rotary member is connected to the rotating spindle and driven to rotate by the rotating spindle; and one end of the swing lever is hinged onto the rotary member at a position deviating from the axis of the rotating spindle, and the other end is hinged onto the support base.

3. The foot massager according to claim 2, wherein the rotating spindle has an outer end portion extending out of the housing, and the rotary member is fixedly connected to the outer end portion.

4. The foot massager according to claim 3, wherein the foot massage mechanism comprises a motor, a drive means, a rotating spindle, and a massage means, in which the motor drives the massage means to undergo massage actions via the drive means and the rotating spindle, and the massage means comprises a roller fitted on the rotating spindle.

5. The foot massager according to claim 4, wherein the drive means is a gear drive mechanism; and the massage means further comprises a carriage, on the top of which massage bumps are provided, where the carriage is connected via a connecting rod and an eccentric wheel structure to the roller and driven by the roller to move forward and backward.

6. The foot massager according to claim 1, wherein the swing drive mechanism is a telescopic push rod, an active push rod of which is hinged to the body, and a base of which is hinged to the support base.

7. The foot massager according to claim 2, wherein the support base comprises a hinge seat, a pin seat and a basal plate, where the hinge seat and the pin seat are fixedly mounted on the basal plate, the swing lever is hinged onto the hinge seat, and the pin is pivoted to the pin seat.

8. The foot massager according to claim 7, wherein the basal plate is provided with a reinforcing plate and a shock absorbing leg.

9. The foot massager according to claim 7, wherein the housing has a through hole, and one end of the pin is fixedly fitted in the housing; and the pin seat is clamped with a sheath, and the other end of the pin passes through the through hole and runs into a bore in the pin sheath.

10. A stretching and massage method by using the foot massager according to claim 1, comprising
Step 1: inflating and expanding the massage air bag to hold the feet in position in the massage cavity; and
Step 2: massaging the feet by the foot massage mechanism, where at the same time, the swing drive mechanism is driven by the foot massage mechanism to work, such that the body swings, which in turn drives the feet to swing with the ankles as a fulcrum for stretching while massaging.
